(19) United States
(12) Patent Application Publication
(10) Pub. No.: US 2009/0265779 A1
(43) Pub. Date: Oct. 22, 2009

(54) TIME-SWITCH DEVICE AND METHOD FOR THE SAME

(76) Inventor: Chih-Wei HSU, Taichung City (TW)

Correspondence Address: SINORICA, LLC, 2275 Research Blvd., Suite 500, ROCKVILLE, MD, 20850, US

(21) Appl. No.: 12/105,142

(22) Filed: Apr. 17, 2008

(51) Int. Cl. G06F 21/00; H04L 9/32; G06F 1/26

(52) U.S. Cl. 726/16

(57) ABSTRACT

A time-switch device and method for the same is provided. The time-switch device mainly comprises a microprocessor unit, and an input element and a key secret element that are connected to the microprocessor unit. The microprocessor unit is connected to a data storage unit storing the time switch method and to a power control unit to control the connected host turning ON or OFF in a predetermined time of the schedule set in the time switch method stored in the time-switch device. Thus, the time-switch device and method for the same may not only force a user to use the host in a limited service time, but also prevent data in the host from being leaked.

### BACKGROUND OF THE INVENTION

1. Field of the Invention

This invention relates to a time-switch device and method for the same and particularly to a time-switch device and method for the same that sets up a host service time.

2. Description of the Prior Art

An ATX power supply is a common PC power system, in which the ATX power supply does not use a mechanical switch as a control switch but uses an enable signal to control the ATX power supply to turn ON or OFF. Relatively, the ATX power supply uses a control chip or a related circuit in a PC system to manage and control the power and still supplies a 5V ready power after turning ON or OFF. Thus, there is a system provider designing a suite of power control software to control the PC to turn ON or OFF.

Consequently, because of the technical defects of described above, the applicant keeps on carving unflaggingly through wholehearted experience and research to develop the present invention, which can effectively improve the defects described above.

### SUMMARY OF THE INVENTION

However, when a PC system enters an operating system and an inputted password is not authorized by an administrator, in the process of trial input of the password for a protected program, a power source supplied to the PC system may be repeatedly enabled or disabled; if a correct password cannot yet inputted in a limited number of times, the PC system is locked and thus does not accept any input from a keyboard. At this time, if the password is continually inputted, in an unique manner, the PC system is powered OFF and then powered ON; however, because the password is used to try to crack the system and the power supply is continually ON and OFF, precise components, for example, in hard disk is quite easily damaged, thereby an effective solution to the issue mentioned above being necessary.

In this invention, a time-switch device and method for the same is provided. The time-switch device receives data inputted from an input element or an encryption element through a microprocessor unit and, through a time-switch means stored in the microprocessor unit, and an administrator setting menu in the time-switch means, controls a connected power control unit and thus control a host connected to the time-switch device, making the host turn ON or OFF at a time set in the time-switch method. Thus, the connected host service time is limited. Further, the time-switch device accepts only a boot signal from the encryption element and makes the host to be set only in the time-switch method, thereby reducing the possibility of an improper invasion into the host in a non-service time and enhancing a data protection function. Thus, the time-switch device or method for the same may not only force a user to use the host in a limited service time, and manage the host for a shutdown operation, but also be widely applied to a company, a factory, an Automatic Teller Machine (ATM), an telecommunication engine room and the like for management, scheduling to turn ON or OFF the host in fixed time.

### BRIEF DESCRIPTION OF THE DRAWINGS

FIG. 1 is a circuit block diagram of a time-switch device in a preferred embodiment of this invention;

FIG. 2 is a circuit block diagram of the time-switch device in another preferred embodiment of this invention;

FIG. 3 is a circuit block diagram of the time-switch device in a further preferred embodiment of this invention;

FIG. 4 is a flow chart of the time-switch device in a preferred embodiment of this invention;

FIG. 5 is a schematic view illustrating a device in a preferred embodiment of this invention; and

FIG. 6 is a schematic view illustrating the device in another preferred embodiment of this invention.

### DETAILED DESCRIPTION OF THE PREFERRED EMBODIMENTS

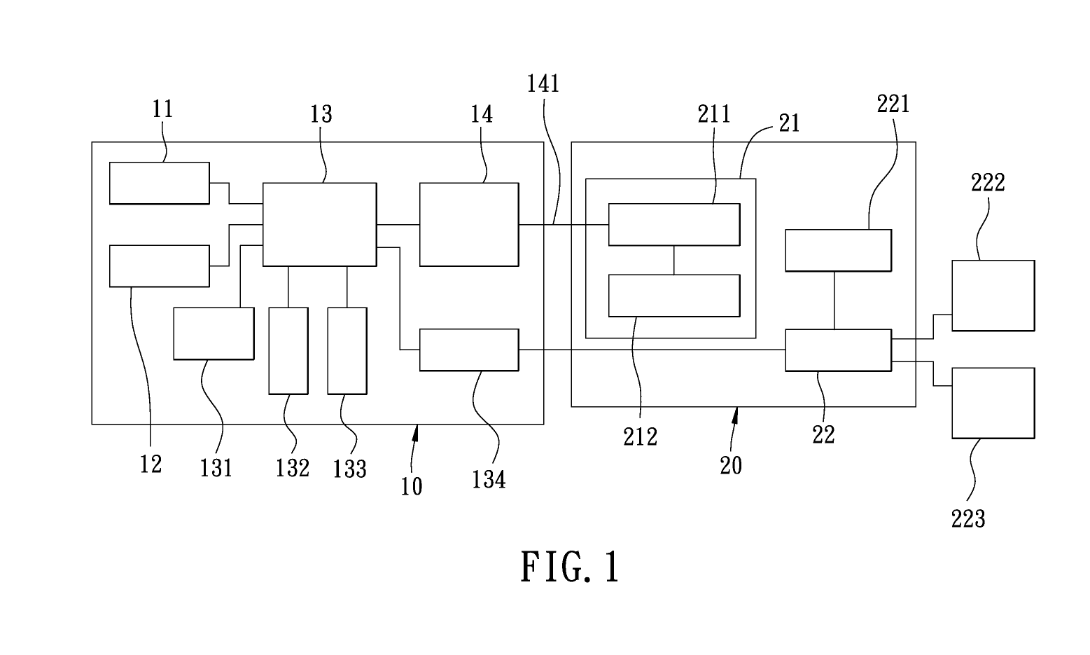

Refer to FIG. 1 illustrating a circuit block diagram of a time-switch device 10 in a preferred embodiment of this invention. The time-switch device 10 is mainly used to control the connected host 20 to automatically turn ON and OFF in a predetermined condition, in which the host 20 mainly comprises a power supply unit 21 and an activating unit 22. The power supply unit 21 mainly comprises a power control connection base 211 and a power supply 212 connected to the base 211. The power control connection base 211 may transmit an enable signal to the host 20 to control the host 20 to turn ON and OFF. Another terminal of the activating unit 22 is connected to an activating switch 221, a hard disk status indicating lamp 222, and a power status indicating lamp 223, and when the host 20 is activated, control signals are separately transmitted to the activating unit 22, in which, the time-switch device 10 mainly comprises an input element 11, a secret key element 12, a microprocessor unit 13, and a power control unit 14.

The input element 11 is used to input predetermined data and is a wired controller in a preferred embodiment of this invention.

The encryption element 12 is used to detect a user ID for an access right. The access right further schedules the time-switch device 10 for an authority, and the encryption element 12 is used to determined whether the user ID may be applied to set up the access right of the time-switch device 10, in which the encryption element 12 selects a group composed of a hardware lock and a software lock. The hardware lock in the preferred embodiment of this invention is an IC card, while the software lock is a password input.

One terminal of the microprocessor unit 13 is separately connected to the input element 11, the encryption element 12, and a data storage unit 131 storing the time-switch method and the administrator setting menu. The microprocessor unit 13 receives, processes, and uses the data inputted by the input element 11, and an acknowledge signal transmitted by the encryption element 12 and then controls the time-switch device 10 to turn ON and OFF. The other terminal of the microprocessor unit 13 is connected to a detecting unit 134. The other terminal of the detecting unit 134 is connected to the activating unit 22 of the host 20. Thus, the detecting unit 134 detects a control signal received by the activating unit 22 from the activating switch 221, the hard disk status indicating lamp 222, and the power status indicating lamp 223, and then detects the host 20, and next transmits an enable signal to the microprocessor unit 13 after processing.

Further, the microprocessor unit 13 is connected to a warning element 132 and a display element 133. The warning element 132 is a warning device used to remind the user of entering a shutdown schedule, such as a speaker or a timer. The display element 133 is used to receive and display a predetermined data transmitted by the microprocessor unit 13.

One terminal of the power control unit 14 is connected to the microprocessor unit 13 to receive the control signal transmitted by the microprocessor unit 13 and supply a standby power to the connected microprocessor unit 13, while the other terminal transmits the control signal to the power unit 21 of the connected host 20 through a power control cable 141. Thus, the control signal transmitted by the microprocessor unit 13 is used to control the connected host 20 powering ON or OFF. The power control unit 14 is further connected to the power control connection base 211 of power unit 21 of the host 10 through a universal connector. Through the transmission of control signal to the power control connection base 211, the power control connection base 211 is made to generate and transmit an enable signal to the host 20, making the host 20 power ON or OFF and controlling the power supply 212 supplying power to the host 20 to turn ON or OFF. The power unit 21 in the preferred embodiment of this invention supplies the standby power to the connected power control unit 14.

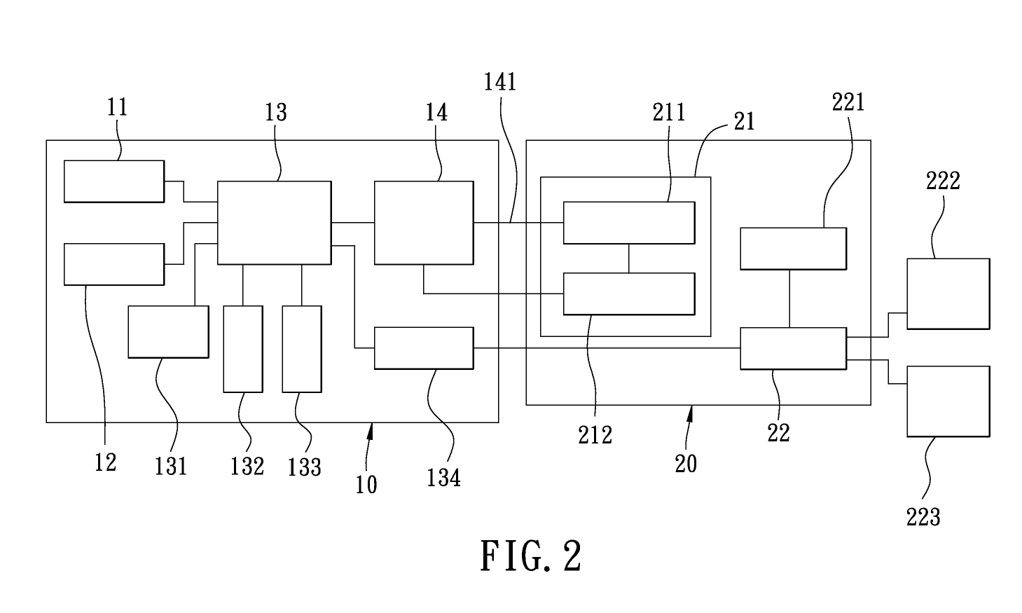

Further, refer to FIG. 2 illustrating a circuit block diagram of the time-switch device in another preferred embodiment of this invention. Main functions of the time-switch device 10 and host 20 are the same as those in the preferred embodiment, so unnecessary details are not given here. One terminal of the power supply 212 and the other terminal of the power control connection base 211 are separately connected to the power control unit 14. The power control unit 14 is used to directly control the power supply 212 supplying the required power to the host 20 and control the power control connection base 211 transmitting the enable signal to turn ON the host 20.

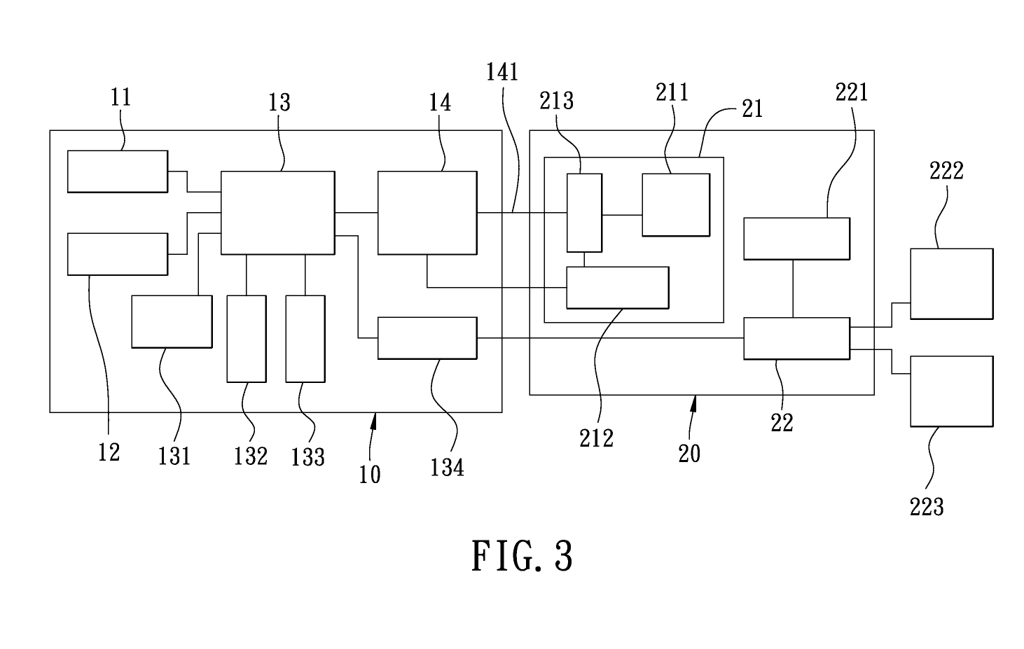

Further, refer to FIG. 3 illustrating a circuit block diagram of the time-switch device 10 in a next preferred embodiment of this invention. The main functions of the time-switch device 10 and host 20 are the same as those in the preferred embodiment, so unnecessary details are not given here. The power control cable 141 connected to the power control unit 14 is connected to an adapter 213. The adapter 213 is connected to the power control connection base 211 and the power supply 212. The power supply 212 is connected to the power control unit 14 to supply the required power to the time-switch device 10. The adapter 213 is connected to only pins for the power supply 212 and power control connection base 211.

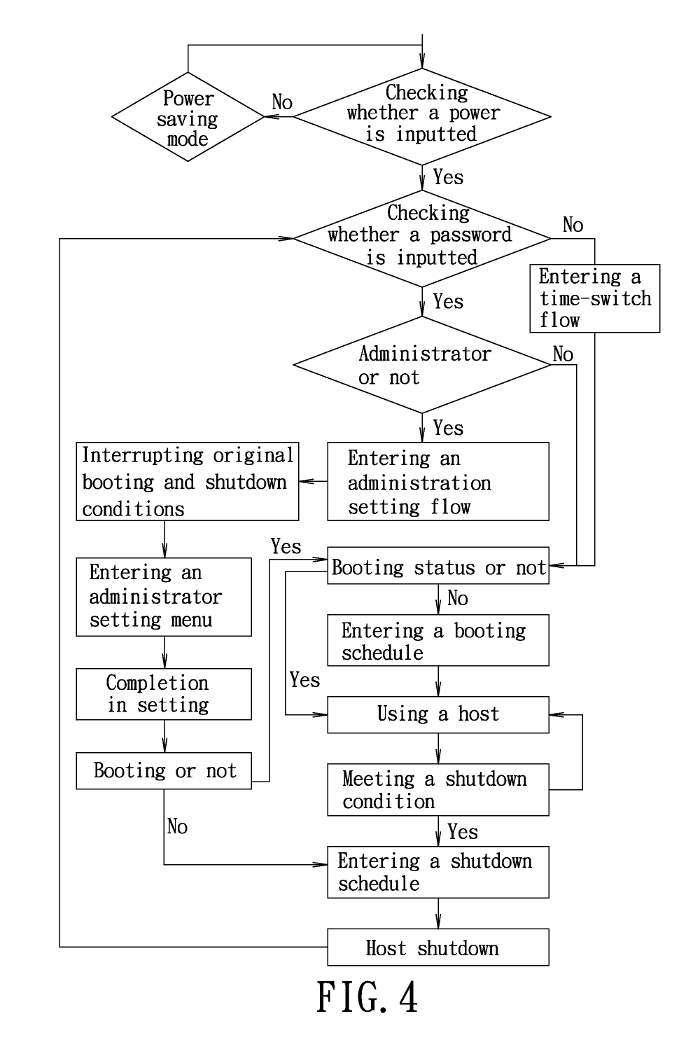

Refer to FIG. 4 showing a flow chart of the time-switch method in a preferred embodiment of this invention, the method mainly comprising the following steps.

(a) Checking whether a power supply is inputted:

A check is first made whether a power supply is inputted to the time-switch device 10; if yes, a next step proceeds to determine an ID; if not, the standby power in the time-switch device 10 is enabled to enter a power saving mode.

(b) Determining an ID:

The time-switch device 10 detects whether a secret key element 12 is inputted; if the secret key element 12 is inputted, determination is made whether the element is an administrator's secret key element 12; if it is not, the host 20 enters a scheduled time switch flow; if it is, the host 20 enters an administrator setting flow, in which the hardware locks 12 in the preferred embodiment of this invention are an IC card as a hardware lock, and a predetermined password as a software lock.

(c) Entering a time switch flow:

Through the detecting unit 134 detecting the control signal indicating a status that is received by the activating unit 22 from the activating switch 221, the hard disk status indicating lamp 222, and the power status indicating lamp 223, the time-switch device 10 determines whether the host 20 turns ON; if not, the host enters a boot-strap schedule following a setting of the time-switch device 10; if yes, the step of using the host 20 proceeds and the time-switch device 10 determines whether the condition of shutdown is met to make the host 20 enter a shutdown schedule during operation.

(d) Entering an administrator setting flow:

The time switch device 10 first interrupts the original booting and shutdown conditions and enters an administrator setting menu; the administrator setting menu mainly comprises an administration password and booting/shutdown settings, in which the booting/shutdown settings are substantially an operation time of the host 20 started, a predetermined booting/shutdown time, or a setting group composed of points of periodical booting/shutdown time, making the host 20 turn ON or OFF in a predetermined time or ON in a specified time; next, after doing the setting, the administrator enters an option of booting; if the booting option is selected, the time-switch flow proceeds; if not, the host 20 directly enters a shutdown schedule.

(e) Entering a booting schedule:

The host 20 is started to complete the predetermined booting schedule, and the time-switch device 10 enters the shutdown schedule.

(f) Entering a shutdown schedule:

When the host 20 is in the shutdown mode, it is made to still stay in the shutdown mode; however, the host 20 stays in the turn-on mode and enters a count-down shutdown condition set by the time-switch device 10 and then is made to enter the shutdown mode in the predetermined time, and step (b) returns for a circular turn of next booting/shutdown.

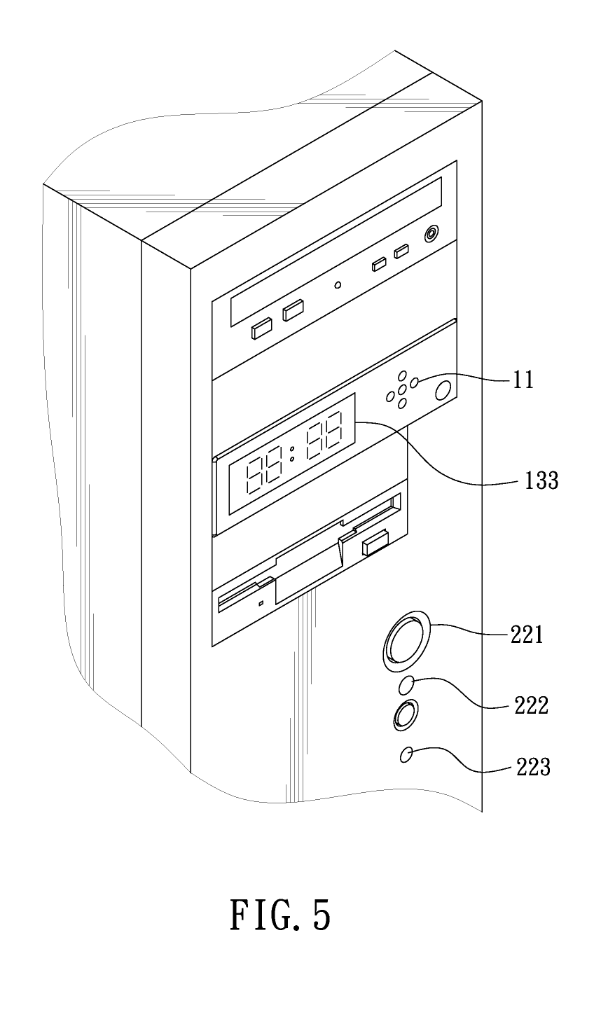

Refer to FIG. 5 illustrating the device in a preferred embodiment of this invention. The host 20 in the preferred embodiment of this invention is a computer, and a generally Desktop PC is provided with a plurality of 3.5-inch or 5.25-inch slot by default. However, a hard disk, a CD-ROM drive, and a diskette drive are arranged, there may be other slots that are not yet used. Thus, the time-switch 10 according to this invention may be modularized in design, and thus the slots may be well used and the time-switch device 10 may be arranged in the slot of the host 20, being connected to the host 20. The input element 11 is a wired controller and connected to the microprocessor unit 13 through a connection cable to transmit the control signal to the microprocessor unit 13. The host 20 is provided with booting and shutdown messages that are a hardware indicating lamp 222 and a power indicating lamp 223. When the activating switch 221 is activated, the hardware indicating lamp 222 and the power indicating lamp 223 are started. When the host 20 enters the booting/shutdown flow, the display element 133 shows a count-down figure, and the user is prompted of entry to the shutdown schedule by the activated warning element 132. Next, the host 20 automatically shuts down in the predetermined time. Besides, if there is a similar slot being provided in a small industrial host, the slot may also be used in the same manner; when a housing of the host 20 is designed in and unnecessarily modularized.

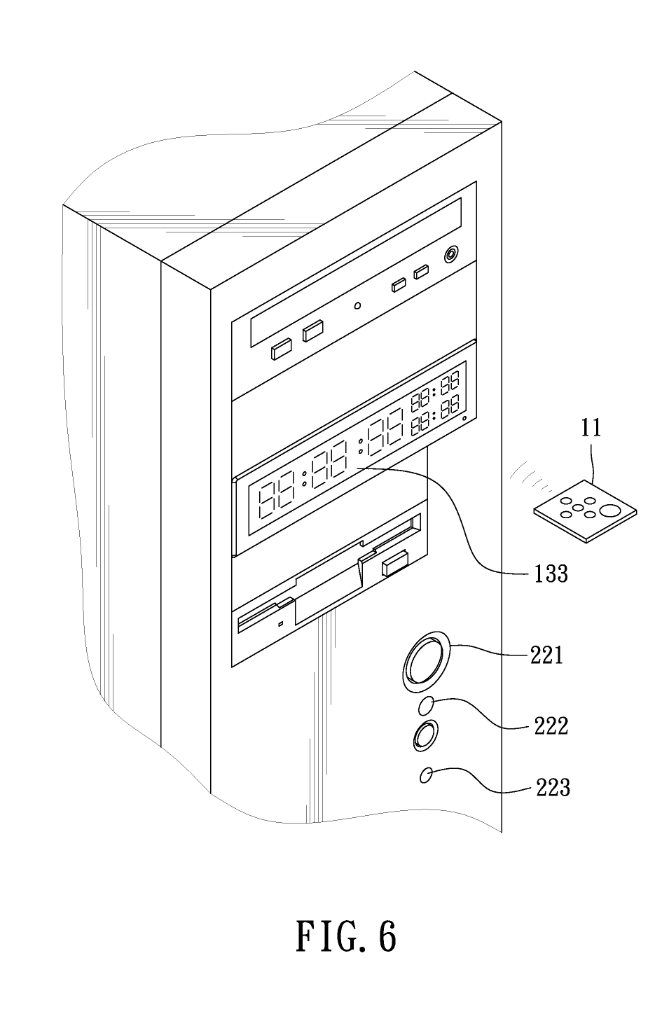

Refer to FIG. 6 illustrating the device in another preferred embodiment of this invention. The display element 133 is provided in the slot of the host 20. The input element 11 is a wireless controller 112 that may transmit the inputted control signal to the microprocessor unit 13 through a wireless receiving and transmitting module (not shown) for a setting of the remote transmission.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A time-switch device, being used to control a connected host automatically turning ON or OFF in a predetermined condition, the host comprising a power supply unit and an activating unit, the power supply unit mainly comprising a power control connection base and a power supply to the host, in which the time-switch mainly comprises:
an input element used to input predetermined data;
a secret key element used to detect a user ID;
a microprocessor unit of which one terminal is connected to a data storage unit storing a time-switch method and the administrator setting menu; the microprocessor unit being separately connected to the input element and the secret key element and receiving the data inputted by the input element and an acknowledge signal transmitted by the secret key element; the other terminal of the microprocessor being connected to a detection unit of which the other terminal is connected to an activating unit of the host to detect the host;
a display element of which one terminal is connected to the microprocessor unit, the display element receiving and displaying the data transmitted by the microprocessor unit; and
a power control unit of which one terminal is connected to the microprocessor unit to receive the control signal transmitted by the microprocessor unit and supply a standby power to the connected microprocessor unit, and the other terminal transmits the control signal to the power unit of the connected host through a power control cable, the control signal transmitted by the microprocessor unit being thereby used to control the connected host 20 powering ON or OFF.

2. The time-switch device according to claim 1, wherein the detecting unit detects an activating switch, a hard disk status indicating lamp, and a power status indicating lamp connected to the other terminal of the activating unit.

3. The time-switch device according to claim 1, wherein the secret key element selects a group composed of a hardware lock and a software lock and is used to determine the user ID for an access right.

4. The time-switch device according to claim 3, wherein the access right further limits the condition of host booting and shutdown and schedules it for the authority.

5. The time-switch device according to claim 3, wherein the hardware lock is an IC card.

6. The time-switch device according to claim 3, wherein the software lock is password input.

7. The time-switch device according to claim 1, wherein the microprocessor is connected to a warning element.

8. The time-switch device according to claim 1, wherein the time-switch device is modularized in design, so the time-switch device is directly embedded into the host.

9. The time-switch device according to claim 1, wherein the input element is a wireless controller.

10. The time-switch device according to claim 1, wherein the input element is a wired controller.

11. The time-switch device according to claim 1, wherein a power control connection base of the power unit is connected to the power supply, the other terminal of the power control connection base is connected to the power control cable and then the power control unit, and the power control cable transmits an enable signal transmitted by the power control unit to enable the power supply to supply a required power to the host and meanwhile start the host.

12. The time-switch device according to claim 1, wherein one terminal of the power supply of power unit is connected to the power control unit, one terminal of the power control connection base is connected to the power control cable and then the power control unit, and thus the power control cable transmits the enable signal transmitted by the power control unit to enable the host and supply the required power to the host.

13. The time-switch device according to claim 1, wherein the power control cable connected to the power control unit is connected to an adapter that is separately connected to the power control connection base and the power supply, and the power supply is connected to the power control unit to supply the required power to the time-switch device.

14. The time-switch device according to claim 1, wherein the power control unit is connected to another external power and thus the external power supplies the required power to the time-switch device.

15. A time switch method, the time-switch device being connected to the host for control to control the host automatically turning ON and OFF depending on a schedule set by the time-switch device, comprising steps of:
(a) checking whether a power source is inputted:
the time-switch device first checking whether a power source is inputted; if yes, a next step proceeding; if not, the standby power in the time-switch device being enabled to enter a power saving mode;
(b) determining an ID:
the time-switch device detecting whether a secret key element is inputted and determining a user ID inputting the secret key element; if the ID is not an administrator, the time-switch device working at step (c), executing a time switch flow set inside, and controlling the host turning ON and OFF at a time set according to the time switch flow; if the ID is an administrator, the time-switch device working at step (d) for an administrator setting flow;
(c) entering a time switch flow:
through the detecting unit, the time-switch device receiving the control signal transmitted by the activating unit to determine whether the host turns ON; if not, the host entering a booting schedule according to a setting of the time-switch device; if yes, a step of using the host proceeding and the time-switch device determining whether the condition of shutdown is met to make the host enter a shutdown schedule during operation;
(d) entering an administrator setting flow:
the time switch device first interrupting the original booting and shutdown conditions and entering an administrator setting menu; when the administrator finishes in the setting, the administrator deciding to turn ON the host or not; if yes, the time switch flow proceeding; if not, the host directly entering the shutdown schedule;
(e) entering a booting schedule:
the host being started to complete the predetermined booting schedule, and the time-switch device entering the shutdown schedule; and
(f) entering a shutdown schedule:
when the host is in the shutdown mode, it being made to still stay in the shutdown mode; however, the host staying in the turn-on mode and entering a count-down shutdown condition set by the time-switch device and then being made to enter the shutdown mode in the predetermined time, and step (b) returning for a circular turn of next booting/shutdown.

16. The time switch method according to claim 15, wherein the administrator setting menu at step (d) mainly comprises an administration password and booting and shutdown settings.

17. The time switch method according to claim 16, wherein the booting/shutdown settings are substantially an operation time of the host started, a predetermined booting/shutdown time, or a setting group composed of points of periodical booting/shutdown time.
